(19) United States
(12) Patent Application Publication
(10) Pub. No.: US 2010/0025394 A1
(43) Pub. Date: Feb. 4, 2010

(54) Apparatus for heating moldings, in particular dental ceramic molding

(75) Inventors: Rudolf Jussel, Feldkirch-Tosters (AT); Jurgen Laubersheimer, Buchs (CH)

Correspondence Address: John C. Thompson, 69 Grayton Road, Tonawanda, NY, 14150, US

(73) Assignee: Ivoclar Vivadent AG

(21) Appl. No.: 12/454,588

(22) Filed: May 20, 2009

(30) Foreign Application Priority Data
Jul. 29, 2008 (DE) 10 2008 035 240.3

(51) Int. Cl. H05B 6/64

(52) U.S. Cl. 219/756; 219/759

(57) ABSTRACT

The invention relates to an apparatus for heating moldings, in particular dental ceramic moldings, with the aid of microwaves or a magnetic field, the apparatus having a susceptor surrounding the molding, in particular according to the type of a container that is closed, said susceptor absorbing microwave radiation or being heated by a magnetic field and emitting heat to the molding. Further, a shielding for electrical and/or magnetic fields is arranged in the path between the microwave oven or the induction coil and the molding, in particular at the inner wall of the susceptor.

### CROSS-REFERENCE TO RELATED APPLICATIONS

This application claims foreign priority benefits under 35 U.S.C. §119(a)-(d) from German patent application ser. no. P 10 2008 035 240.3 filed Jul. 29, 2008.

### TECHNICAL FIELD

The invention relates to an apparatus for heating moldings with the aid of microwaves or magnetic fields, in particular for heating dental ceramic moldings.

### BACKGROUND OF THE INVENTION

It has been known for some time now that susceptors can be used for heating objects such as moldings, in order to ensure an uniform heating of the moldings.

Dental ceramics that are often oxide ceramics such as zirconium oxide for example, couple extremely worse to microwaves at temperatures below 700° C. or are not magnetizable. For this reason, when heating such ceramics, usually a so-called susceptor is used that absorbs the microwave radiation and passes it on in the form of thermal radiation. Typical susceptors show reduced absorption properties at high temperatures of more than 1000° C., such that at high temperatures the moldings are immediately heated by the microwave radiation, in addition to the indirect heating by the susceptors. This behavior is desired in order to achieve an efficiency as high as possible and in order to take best advantage of the microwave radiation that is coupled into the microwave oven by the microwave generator—for the most part with the aid of a waveguide. Thus, typically an efficiency of approximately 60% can be achieved.

On the other hand, when dealing with nonliquid objects to be heated, for example also with moldings, it is desired to ensure a homogenization of the heating in order to avoid a thermal shape distortion in the moldings for example. In this case it has already been proposed to thermally couple the one ore more moldings to the susceptors as good as possible, in order to thus provide a uniform heating. It is also possible to combine this measure with the use of a so-called rotary disk or turn table, by means of which either the molding with susceptor or the microwave radiator or at least the microwave radiation are continuously rotated, in order to avoid point by point heatings at a specific location.

Occasionally, it has also already been proposed to apply a susceptor layer in the form of a paste to the surface of the moldings, however presenting the disadvantage that the susceptor then has to be renewed for each molding that is to be heated, and the application of a susceptor layer then is not possible, if impurities in the molding due to foreign particles represent a problem.

For the same reason it is forbidden with dental ceramics to typically add or mix in carbon or carbides into the dental ceramic part itself, since in this case the desired physical properties that can be achieved with the aid of a sintering process, would be considerably impaired.

From WO 00/78243 is has basically been known to use microwave radiation for heating the dental ceramic part up to the firing temperature of the dental ceramic part. This solution, too, uses a susceptor element in order to thus ensure an indirect heating, whereas specific measures for measuring the temperature are required.

In this connection and specifically with dental ceramic products, local overheating or excess heating is a particular problem. In an advantageous refinement of the solution according to WO 00/78243 a specifically tuned resonator is to be used that is to comprise a thin sheet of platinum that forms part of the resonator, at its inner wall. With the aid of specifically injected microwave radiation it is intended to counteract the formation of temperature gradients in order to nevertheless generate a substantially uniform temperature within the furnace interior.

In this case it is intended to apply a rotary field distribution to the molding that is to made from dental ceramics, in which case a turn table known per se is used.

On the other hand, if a molding is used that is not circle symmetric, the rotary position influences the field distribution in the resonator particularly in the case that a comparatively small resonator and a comparatively large molding are used.

On the other hand, in particular large moldings such as multi-chain bridges are especially sensitive with regard to temperature gradients. In particular, it has been realized that a local heating being too strong may result in material damages on the surface of a dental ceramic molding such that the dental restoration part that is to be produced, leaves much to be desired.

Further, it has been known for a longer period of time now, for example from EP 294 983 A2, to use as susceptors ceramic materials that absorb microwaves. Preferably, unsintered ceramic compounds are used, since the absorption properties of unsintered compounds are regarded as being superior. On the other hand, however, it is caused that such compounds typically are considered to be out of the question when they are used for higher operating temperatures that are necessary for sintering ceramic moldings for example.

Moreover, it has been known for a still longer period of time to employ electrically conductive, for the most part resistive coatings as a microwave trap. One example for this case can be taken from U.S. Pat. No. 3,853,612. Materials of this kind have been used, even if they emit relatively little heat at high temperatures due to their comparatively small weight, unlike ceramic susceptors.

### OBJECTS AND SUMMARY OF THE INVENTION

According to the invention it is provided that the heating of the preferably dental ceramic moldings takes place completely or nearly completely with the aid of a modified manner of heat transfer as opposed to microwave radiation. Preferably, a double tight, combined susceptor is provided in this case that—on the one hand—consists of a ceramic susceptor material such as silicon carbide, and—on the other hand—can consist of a metallic, at least semiconducting susceptor or any other susceptor having a high density, at its inner side. This “internal susceptor” can also be used as a microwave reflector such that the microwave radiation at first still passing through the ceramic susceptor, is reflected at the inside and then again passes through the susceptor in order to be absorbed again.

Thus, it is inventively achieved that practically the double effective wall thickness of the susceptor is available, presenting in this respect a considerable progress with regard to the reduction of the material masses required, but also with regard to the spatial relationships.

It is possible to use any suitable materials as main susceptor, which materials have a microwave-absorbing effect already at low temperatures reaching to the high temperature range. It is understood that low temperatures are room temperature or a temperature below for example. Temperatures of 1,000° C., 1,100° C. or 1,200° C. and still higher temperatures are considered to be high temperatures. Preferably, materials providing a particularly high sintering temperature are used for the ceramic susceptor. For example, one of the following materials can be selected: silicon carbide, titanium carbide, zirconium carbide, hafnium carbide, vanadium carbide, tantalum carbide, molybdenum carbide, niobium carbide, silicon boride, hafnium boride, zirconium boride, silicon nitride, zirconium nitride, calcium boride or mixtures thereof. Further materials are diamond or graphite.

It is particularly expedient, if the ceramic masses that can also include a ceramic binder, are not deliquescent. In this case it is avoided that the absorbed water evaporizes due to the dipole effect and damages or destroys the ceramic compound or mass due to its increase in volume.

As material for the inner layer of the susceptor according to the invention a metallic material, e.g. platinum, is preferably used that functions as a microwave shielding or can be magnetically heated up through induction. This can be effected by using metals that are vapor-deposited at high temperatures and that are stable at the temperature required for sintering the moldings. The metallization acts like a Faraday cage in the case of microwave fields, so that the microwave radiation as heat transfer mechanism is ruled out. The susceptor thus inventively heats up the molding with the aid of a different heat transfer mechanism, preferably with the aid of infrared radiation or heat conduction.

Whereas according to the invention it is preferred to use microwaves to be applied as primary radiation, it is also considered to use electromagnetic inductions as primary heat transfer medium. The secondary heat transfer mechanism, that is to say from the susceptor to the molding, is always different from the primary heat transfer mechanism, and is formed by heat convection, thermal radiation or heat conduction for example.

In the case of an inductive impingement of the susceptors it is important that the susceptors completely absorb the induction heat applied. Suitable measures may be taken to effect this, for example by forming the interior of the susceptor like a Faraday cage or even lining it with a metal only.

Also in this case a significant temperature homogenization arises and also radiation-sensitive moldings may be heated in the desired manner without problems.

Surprisingly, with the aid of this measure it can be guaranteed that no selective overheating occurs at places that would damage the molding according to the invention. Microwave radiation typically heats the objects that are to be heated starting from their surface, and in this respect has a quite small penetration depth, especially in the case if frequencies of approximately 2.45 GHz are used, and not—as it is also known—frequencies of approximately 900 MHz. According to the invention large-scale but gracefully built or slender dental ceramic moldings are prevented from overheating locally due to the fact that microwave radiation induces a high temperature gradient. According to the invention, the microwave radiation inside the inventively double-tight susceptor is rather reduced by more than the factor 100, typically by the factor 10,000, and thus is no longer relevant for the heating process or is secondary. Surprisingly, with the aid of the nearly complete indirect heating of the molding according to the invention, it is possible to ensure a good heat efficiency, especially in the case that a susceptor is used that is adjusted in its shape to the shape of the molding and that is not dimensioned to be too large.

In this connection it is particularly expedient, if the interior or inner space of the susceptor according to the invention is lined with a good heat-conducting material. Typically, metal is a good heat conductor and thus suitable to be used for a heat homogenization. In the case of a heating up speed of the susceptor of 50° K/min for example and a size of the susceptor that is suitable for dental ceramic moldings, and in this respect provides only few centimeters interior length, it is possible to achieve an interior temperature gradient of less than 5°, preferably less than 3°.

The lining of the interior or inner space can be provided in any suitable manner.

For example it is possible to provide the wall of the susceptor in one piece or in more pieces. Possible materials for the interior lining are a high-compressed ceramic layer, but also a ceramic layer for example that is enriched with a metal powder, a metallic coating, a vaporized metal layer, a plated-on metal layer, a high-temperature heat resistant semiconductor layer, etc.

Typically, the susceptor is formed in two pieces in a manner known per se, for example it may be formed as a substantially square-shaped container with a lid or cover. It is particularly expedient, however, to construct the susceptor from a disk having the wall thickness of the susceptor, said disk being covered by a hood-shaped cylindrical susceptor. This solution allows to cool down the sintered dental molding without any vibrations, for example by taking off the hood-shaped lid or cover of the susceptor. With this solution, it is preferred at first to allow the susceptor to cool down in closed form together with the sintered dental molding received therein until prehardening of the molding has taken place. As soon as the cooling temperature gradient clearly decreases, the hood of the susceptor can then be taken off, thus again accelerating the cooling down process.

According to the invention, the susceptor is embodied such that it has good absorption properties at any temperature ranges encountered. In order to provide the tightness to microwaves, the interface between the susceptor container and its cover or lid can be embodied as a labyrinth seal or at least in a corrugated manner.

It is also possible to heat the susceptor container with the aid of an electrical resistance heating, for example to a temperature of 700 or 800° C., and to switch on the microwave radiation as soon as this temperature is reached.

Instead of the electrically conductive coating consisting of a metal such a platinum, it is also possible to use a coating made from graphite, and possible openings that can e.g. be provided in order to enable a gas to flow through the susceptor, can be formed as a lambda trap based on the wavelength of the microwave radiation used.

Although according to the invention it is typically preferred to provide an arrangement of the susceptor container that is stationary and thus mechanically easier to implement, it is possible as well to use a rotary table that rotates the susceptor container including the molding, or to rotate the microwave field in any other manner known per se.

In a further advantageous refinement it is preferred that the microwave shielding increases the ratio between absorbed and passing-through microwave radiation to more than 100:1, in particular more than 1000:1 and preferably to more than 10000:1.

In a further advantageous refinement it is provided that the susceptor absorbs microwave radiation and emits radiation the frequency of which is clearly below 2,455 GHz, in particular below 900 MHz.

In a further advantageous refinement it is provided that the radiation emitted by the susceptor has an emission maximum in the infrared range, in particular at a wavelength of somewhat below 1000 μm, which radiation preferably is distributed like a Gaussian curve.

In a further advantageous refinement it is provided that a shielding, in particular a microwave shielding, is arranged in the optical path between the radiation source and the molding, in particular at the inner wall of the susceptor, said shielding substantially completely preventing the supply of electromagnetic radiation to the molding.

In a further advantageous refinement it is provided that the container formed by the susceptor is embodied as a thermal treatment chamber having a homogeneous temperature field, in which the one or more moldings that is/are to be heated is/are located.

In a further advantageous refinement it is provided that the susceptor absorbs electromagnetic radiation and emits thermal radiation.

In a further advantageous refinement it is provided that a different heat transfer mechanismus between susceptor and molding is used than between microwave oven and susceptor, said heat transfer mechanismus in particular being convection, radiation and/or thermal conduction.

In a further advantageous refinement it is provided that the radiation emitted by the susceptor comprises an emission maximum in the infrared range.

In a further advantageous refinement it is provided that the susceptor is formed such that it is absorbent and/or impervious to electromagnetic radiation, in particular, however, at least comprises one opening.

In a further advantageous refinement it is provided that the microwave shielding is made of a material that strongly absorbs and/or reflects microwaves, and in particular comprises metal.

In a further advantageous refinement it is provided that the microwave shielding is made of a material that has a particularly high absorption coefficient for microwave radiation, in particular is made of silicon carbide.

In a further advantageous refinement it is provided that the molding rests on the susceptor within the container or the thermal treatment chamber, where appropriate by means of a suitable support material, in particular in an adynamic manner and with uniform thermal contact with the susceptor.

In a further advantageous refinement it is provided that the susceptor and/or a layer applied to the inner side of the container or of the thermal treatment chamber is formed as a good thermal conductor and homogenizes the temperature in the interior of the susceptor.

In a further advantageous refinement it is provided that the susceptor—and where appropriate the thermal conductor—comprises a connecting flange for gas that flowss through the susceptor and where appropriate through the thermal conductor.

In a further advantageous refinement it is provided that the microwave shielding is attached to the inside of the susceptor and in a lining manner.

In a further advantageous refinement it is provided that the microwave shielding is formed in one piece with the susceptor, in particular is formed at its inner wall by redensification of the same.

In a further advantageous refinement it is provided that the container is constructed by at least two parts and/or at least two layers.

In a further advantageous refinement it is provided that the shielding has a shielding effect at temperatures of 0 to 1750 degrees.

### BRIEF DESCRIPTION OF THE FIGURES

Further advantages, details and features emerge from the following description of several exemplary embodiments of the invention with reference to the drawings, in which:

FIG. 1 shows a diagrammatic view of an apparatus according to the invention for heating moldings, including a microwave and a susceptor;

FIG. 2 shows a diagrammatic view of a susceptor for use in an apparatus according to the invention in a first embodiment;

FIG. 3 shows a diagrammatic view of a susceptor for use in an apparatus according to the invention in a second embodiment;

FIG. 4 shows a diagrammatic view of a susceptor for use in an apparatus according to the invention in a third embodiment; and

FIG. 5 shows a diagrammatic view of a susceptor for use in an apparatus according to the invention in a fourth embodiment.

### DETAILED DESCRIPTION

The apparatus according to the invention for heating moldings comprises a microwave oven 10 that is impinged with microwave radiation 14 with the aid of a microwave generator (not shown) and with the aid of a waveguide 12.

A susceptor 16 according to the invention is arranged within the microwave oven, said susceptor enclosing and receiving a molding 18. In the illustrated exemplary embodiment, the container-shaped susceptor 16 is centrally received within the cylindrical microwave oven 10 in a manner known per se. It is to be noted that the susceptor 16 can have any other suitable shape.

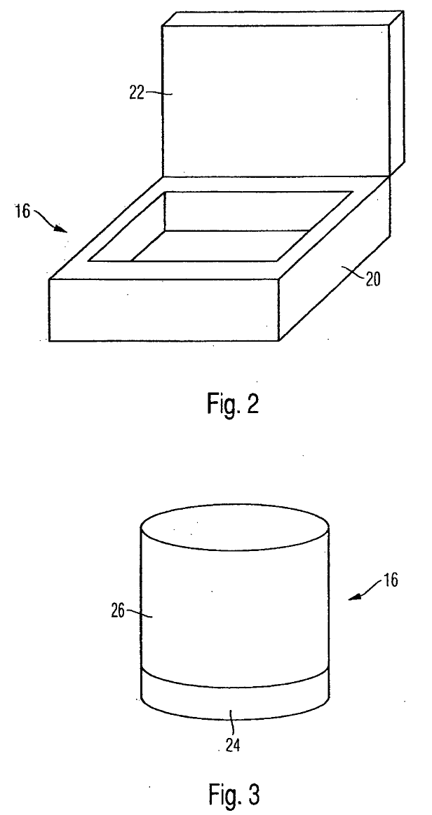

FIG. 2 shows a susceptor 16 having square-shape. The embodiment according to FIG. 2 shows a two-part susceptor comprising a susceptor lower part 20 and a susceptor cover or lid 22. The cover or lid 22 for example can be flexibly connected to the lower part 20, whereby, however, it is preferably set seated. The susceptor container has an uniform wall thickness that preferably amounts to about 20 mm, but for example can amount to a wall thickness of only 0.1 mm, or can amount to a wall thickness of 50 mm. The container preferably consists of silicon carbide and is coated at its inside with platinum for providing the inventive microwave shielding, said coating also being formed in the inside of the cover or lid that is illustrated in the open state in FIG. 2.

A modified embodiment of a susceptor 16 is illustrated in FIG. 3. In this figure the susceptor 16 comprises a circular base 24 that is covered by a hood 26. The molding 18 is destined to be received centrally on the base 16. The base 24 is coated with a well heat-conducting layer that serves to homogenize the temperature inside the susceptor 16.

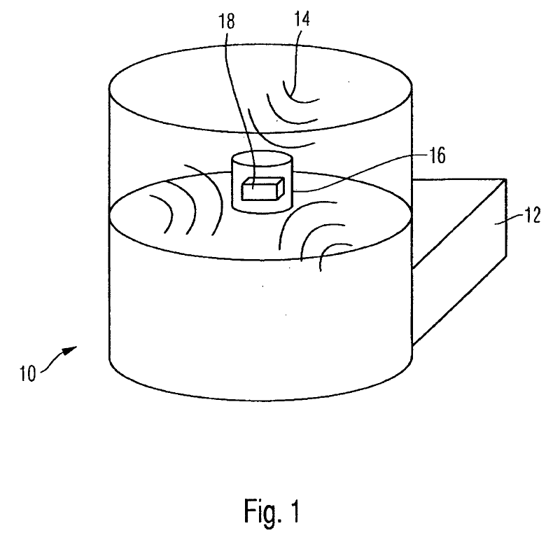

Both in the embodiment according to FIG. 1 and in the embodiment according to FIG. 2 it is provided that the cover 22 or the hood 26, respectively, rests positively on the lower part 20 or the base 24, respectively. In this case, at least a shoulder, a groove or any other recess is provided that serves to achieve a positive locking. Preferably, the positive locking is formed in a ring-shaped manner according to the type of a sealing such that it is not possible for the microwave radiation to enter or pass through at this location.

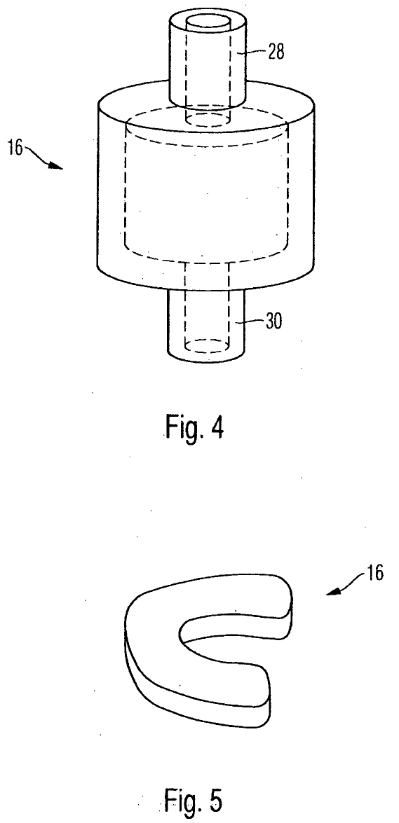

A modified arrangement of a susceptor 16 according to the invention becomes apparent from FIG. 4. In this arrangement it is provided that gas flows through the susceptor. In this case cylindrical gas flow connections 28 and 30 are provided that are formed centrally at opposite sides of the container, for example at the upper side and lower side of the substantially cylindrical susceptor container. The openings provided in this respect are also surrounded by a susceptor material having the same wall thickness. The existing openings, however, are embodied as a lambda trap so that microwave radiation cannot enter at this location.

FIG. 5 shows a further modified embodiment of a susceptor 16. The interior shape of the intended shape of the susceptor 16 substantially corresponds to the outer shape of the dental molding that is to be produced, for example a bridge that is to span several teeth. Also in this case it is preferred that a two-part arrangement is provided, and it is to be noted that both the inside of the susceptor 16 according to FIG. 5 and the inside of the other embodiments is provided with a suitable coating to form a microwave shielding.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the terms as used in the claims are intended to include not only the designs illustrated in the drawings of this application and the equivalent designs discussed in the text, but are also intended to cover other equivalents now known to those skilled in the art, or those equivalents which may become known to those skilled in the art in the future.

What is claimed is:

1. Apparatus for heating moldings, in particular dental ceramic moldings, with the aid of a microwave generator or an induction heating device that apply an electromagnetic radiation to a susceptor, the apparatus comprising:
an electromagnetic radiation generator; and
a susceptor surrounding the molding to be heated, in particular in the manner of a closed container, which susceptor absorbs electromagnetic radiation and emits thermal radiation to the molding, wherein the electromagnetic radiation heats up the susceptor (16) and wherein the susceptor (16) shields the molding (18) from electromagnetic radiation.

2. Apparatus as claimed in claim 1, wherein a shielding, in particular a microwave shielding, is arranged between the radiation source and the molding (18), in particular at the inner wall of the susceptor (16), said shielding substantially completely preventing the supply of electromagnetic radiation to the molding (18).

3. Apparatus as claimed in claim 1, wherein the container formed by the susceptor (16) is embodied as a thermal treatment chamber having a homogeneous temperature field, in which the one or more moldings (18) that is/are to be heated is/are located.

4. Apparatus as claimed in claim 1, wherein the susceptor (16) absorbs electromagnetic radiation and emits thermal radiation.

5. Apparatus as claimed in claim 1, wherein the electromagnetic generator is a microwave oven, and a different heat transfer mechanismus between susceptor (16) and molding (18) is used than between microwave oven (10) and susceptor (16), said heat transfer mechanismus in particular being convection, radiation and/or thermal conduction.

6. Apparatus as claimed in claim 1, wherein the radiation emitted by the susceptor (16) comprises an emission maximum in the infrared range.

7. Apparatus as claimed in claim 1, wherein the susceptor (16) is formed such that it is absorbent and/or impervious to electromagnetic radiation, in particular, however, at least comprises one opening.

8. Apparatus as claimed in claim 2, wherein the microwave shielding is made of a material that strongly absorbs and/or reflects microwaves, and in particular comprises metal.

9. Apparatus as claimed in claim 2, wherein the microwave shielding is made of a material that has a particularly high absorption coefficient for microwave radiation (14), in particular is made of silicon carbide.

10. Apparatus as claimed in claim 1, wherein the molding (18) rests on the susceptor (16) within the container or the thermal treatment chamber, where appropriate by means of a suitable support material, in particular in an adynamic manner and with uniform thermal contact with the susceptor (16).

11. Apparatus as claimed in claim 3, wherein a layer applied to the inner side of the container or of the thermal treatment chamber is formed as a good thermal conductor and homogenizes the temperature in the interior of the susceptor (16).

12. Apparatus as claimed in claim 11, wherein the susceptor (16)—and where appropriate the thermal conductor—comprises a connecting flange for gas that flows through the susceptor (16), and where appropriate through the thermal conductor.

13. Apparatus as claimed in claim 3, wherein the microwave shielding is attached to the inside of the susceptor (16) and in a lining manner.

14. Apparatus as claimed in claim 3, wherein the microwave shielding is formed in one piece with the susceptor (16), in particular is formed at its inner wall by redensification of the same.

15. Apparatus as claimed in claim 1, wherein the container is constructed by at least two parts and/or at least two layers.

16. Apparatus as claimed in claim 2, wherein the shielding as a shielding effect at temperatures of 0 to 1750 degrees.

17. Apparatus as claimed in claim 8, wherein the susceptor consists of a ceramic susceptor material such as silicon carbide.
